(19) United States
(12) Patent Application Publication
(10) Pub. No.: US 2021/0215092 A1
(43) Pub. Date: Jul. 15, 2021

(54) AIR INTAKE APPARATUS OF INTERNAL COMBUSTION ENGINE

(71) Applicant: AISIN SEIKI KABUSHIKI KAISHA, Kariya-shi (JP)

(72) Inventor: Yasuhiko ESAKI, Kariya-shi (JP)

(73) Assignee: AISIN SEIKI KABUSHIKI KAISHA, Kariya-shi (JP)

(21) Appl. No.: 17/128,871

(22) Filed: Dec. 21, 2020

(30) Foreign Application Priority Data
Jan. 14, 2020 (JP) 2020-003875

(51) Int. Cl. F02B 31/06; F02M 35/10; F02D 9/10

(52) U.S. Cl. CPC F02B 31/06; F02M 35/10262; F02D 9/10; F02M 35/10255

(57) ABSTRACT

An air intake apparatus of an internal combustion engine includes an intake passage, an intake air flow control valve, a housing portion configured to house the intake air flow control valve, a swirl opening arranged at a first side of the intake air flow control valve to generate swirl, and a tumble opening arranged at a second side of the intake air flow control valve to generate tumble. The swirl opening is provided at one of the intake air flow control valve and a portion between the intake passage and the intake air flow control valve, the tumble opening being provided at the other of the intake air flow control valve and the portion between the inner surface of the intake passage and the intake air flow control valve. The intake air flow control valve rotates to achieve a switching between a swirl state and a tumble state.

### CROSS REFERENCE TO RELATED APPLICATIONS

This application is based on and claims priority under 35 U.S.C. § 119 to Japanese Patent Application 2020-003875, filed on Jan. 14, 2020, the entire content of which is incorporated herein by reference.

### TECHNICAL FIELD

This disclosure generally relates to an air intake apparatus of an internal combustion engine.

### BACKGROUND DISCUSSION

A known air intake apparatus of an internal combustion engine including an intake air flow control valve that is provided at an intake passage is disclosed in JP2004-92487A (which is hereinafter referred to as Reference 1), for example.

The air intake apparatus disclosed in Reference 1 includes an intake air control valve (intake air flow control valve) provided at an intake passage that is connected to a combustion chamber. The intake air control valve includes a rotary shaft about which the control valve is rotatable within the intake passage. The air intake apparatus is configured so that swirl is generated at one side of the control valve in a rotation direction thereof in a state where the intake passage is maximally closed by the control valve. The air intake apparatus is also configured so that tumble is generated at the one side of the control valve when the control valve rotates in an opening direction from the aforementioned state where the intake passage is maximally closed.

According to the aforementioned air intake apparatus, swirl and tumble are both generated at the one side of the control valve in the rotation direction thereof. This causes the swirl and the tumble to interact with each other at the one side of the control valve, which may prevent a generation of pure swirl and tumble.

A need thus exists for an air intake apparatus which is not susceptible to the drawback mentioned above.

### SUMMARY

According to an aspect of this disclosure, an air intake apparatus of an internal combustion engine includes an intake passage connected to a combustion chamber of the internal combustion engine to supply an intake air to the combustion chamber, an intake air flow control valve including a rotary shaft and provided at the intake passage to be rotatable to the rotary shaft, the intake air flow control valve controlling a flow of intake air, a housing portion provided at the intake passage and configured to house the intake air flow control valve, a swirl opening arranged at a first side in a rotation direction of the intake air flow control valve to generate swirl within the combustion chamber, and a tumble opening arranged at a second side in the rotation direction of the intake air flow control valve to generate tumble within the combustion chamber. The swirl opening is provided at one of the intake air flow control valve and a portion between an inner surface of the intake passage and the intake air flow control valve, the tumble opening being provided at the other of the intake air flow control valve and the portion between the inner surface of the intake passage and the intake air flow control valve. The intake air flow control valve rotates to achieve a switching between a swirl state where the swirl opening is opened at the first side in the rotation direction of the intake air flow control valve and a tumble state where the tumble opening is opened at the second side in the rotation direction of the intake air flow control valve.

According to another aspect of this disclosure, an air intake apparatus of an internal combustion engine includes an intake passage connected to a combustion chamber of the internal combustion engine to supply an intake air to the combustion chamber, an intake air flow control valve including a rotary shaft and provided at the intake passage to be rotatable to the rotary shaft, the intake air flow control valve controlling a flow of intake air, a housing portion provided at the intake passage and configured to house the intake air flow control valve, a first intake air flow generating opening arranged at a first side in a rotation direction of the intake air flow control valve to generate a first intake air flow within the combustion chamber, and a second intake air flow generating opening arranged at a second side in the rotation direction of the intake air flow control valve to generate a second intake air flow within the combustion chamber. The first intake air flow generating opening is provided at one of the intake air flow control valve and a portion between an inner surface of the intake passage and the intake air flow control valve, the second intake air flow generating opening being provided at the other of the intake air flow control valve and the portion between the inner surface of the intake passage and the intake air flow control valve. The intake air flow control valve rotates to achieve a switching between a first intake air flow state and a second intake air flow state, the first intake air flow state where the first intake air flow generating opening is opened and the second intake air flow generating opening is fully closed at the first side in the rotation direction of the intake air flow control valve, the second intake air flow state where the first intake air flow generating opening is fully closed and the second intake air flow generating opening is opened at the second side in the rotation direction of the intake air flow control valve.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a schematic configuration of an engine including an air intake apparatus according to first to third embodiments disclosed here;

FIG. 2 is a cross-sectional view of the engine including the air intake apparatus and an intake air flow control valve provided at the air intake apparatus according to the first embodiment as viewed from a downstream side of an air flow direction;

FIG. 3 is a perspective view of the intake air flow control valve of the air intake apparatus according to the first embodiment;

FIG. 4 is a cross-sectional view taken along line IV, V, VI, VII, VIII, IV, X in FIG. 3 and illustrating the intake air flow control valve in a tumble state of the air intake apparatus according to the first embodiment as viewed from the downstream side of the air flow direction;

FIG. 5 is a cross-sectional view taken along line IV, V, VI, VII, VIII, IV, X in FIG. 3 and illustrating the intake air flow control valve in a swirl-tumble state of the air intake apparatus according to the first embodiment as viewed from the downstream side of the air flow direction;

FIG. 6 is a side view of an actuator that rotate the intake air flow control valve of the air intake apparatus according to the first embodiment;

FIG. 7 is a perspective view of the actuator that rotate the intake air flow control valve of the air intake apparatus according to the first embodiment;

FIG. 8 is a cross-sectional view taken along line IV, V, VI, VII, VIII, IV, X in FIG. 3 and illustrating a state where a valve body of the intake air flow control valve is fully housed in a housing portion of the air intake apparatus according to the first embodiment;

FIG. 9 is a cross-sectional view taken along line IV, V, VI, VII, VIII, IV, X in FIG. 3 and illustrating an intake air flow control valve in a tumble state of an air intake apparatus according to a second embodiment;

FIG. 10 is a cross-sectional view taken along line IV, V, VI, VII, VIII, IV, X in FIG. 3 and illustrating the intake air flow control valve in a swirl state of the air intake apparatus according to the second embodiment;

FIG. 11 is a cross-sectional view taken along line IV, V, VI, VII, VIII, IV, X in FIG. 3 and illustrating an intake air flow control valve in a fully closed state of an air intake apparatus according to a third embodiment; and

FIGS. 12A to 12F are diagrams each illustrating an intake air flow control valve as viewed from a downstream side of an air flow direction according to modified examples.

### DETAILED DESCRIPTION

Embodiments are explained with reference to the attached drawings.

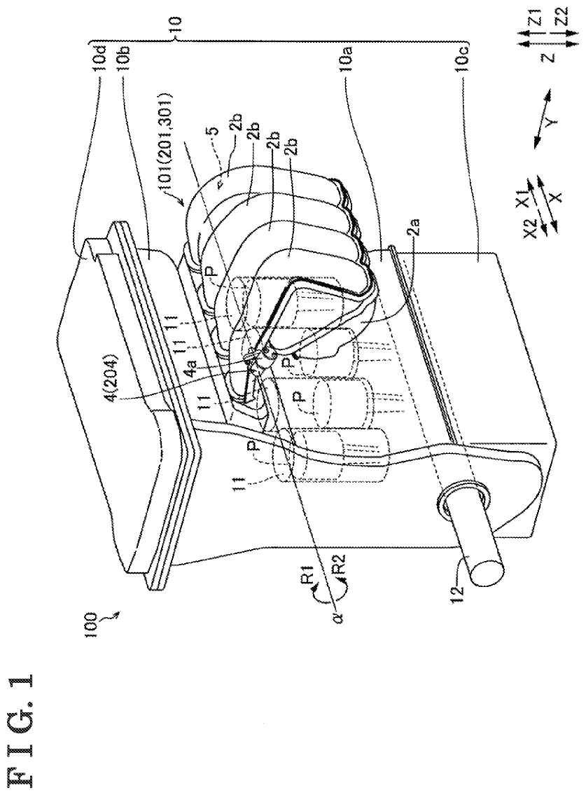

An air intake apparatus (intake apparatus) 101 of an engine 100 serving as an internal combustion engine according to a first embodiment is explained with reference to FIGS. 1 to 8.

As illustrated in FIG. 1, the engine 100 used for a vehicle (automobile, for example) includes an engine body 10 and the intake apparatus 101.

The engine body 10 includes a cylinder block 10a, a cylinder head 10b, a crankcase 10c, and a head cover 10d. The cylinder head 10b is tightened to an upper surface (i.e., to a Z1 side) of the cylinder block 10a. The crankcase 10c is tightened to a lower surface (i.e., to a Z2 side) of the cylinder block 10a. The head cover 10d covers an upper portion of the cylinder head 10b to be tightened thereto.

The engine 100 serves as an inline multi-cylinder (four-cylinder in the embodiment) engine and includes plural (four) cylinders 11 which extend in an up and down direction and within which respective pistons P move in a reciprocating manner. Such movement of each piston P in the cylinder 11 achieves repetition of a cycle consisting of intake, compression, expansion (combustion), and exhaustion to thereby rotate a crankshaft 12. The direction where the cylinders 11 are arranged next to one another is a direction where the crankshaft 12 extends.

In each drawing, the arrangement direction of the cylinders 11 (i.e., the direction where the cylinders 11 are arranged next to one another) is indicated by an X direction, an up and down direction being indicated by a Z direction (an upper direction and a lower direction corresponding to a Z1 direction and a Z2 direction), a direction orthogonal to the X direction and the Z direction being indicated by a Y direction. Additionally, a rotation direction of an intake air flow control valve 3 (explained later) of the intake apparatus 101 is indicated by an R direction of which one side (first side) is indicated by an R1 side and of which the other side (second side) is indicated by an R2 side. In the following explanation, an upstream side and a downstream side are based on an air flow direction.

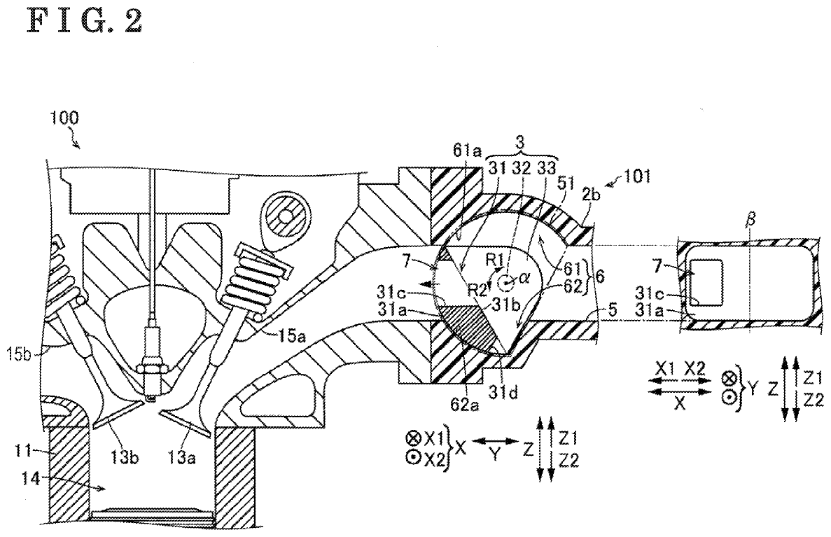

The cylinder head 10b incorporates intake valves 13a and exhaust valves 13b each of which is periodically opened and closed as illustrated in FIG. 2. The cylinder head 10b includes combustion chambers 14, intake ports 15a sending intake air to the combustion chambers 14, and exhaust ports 15b exhausting burnt gas. The combustion chamber 14, the intake port 15a, and the exhaust port 15b are provided at each cylinder 11 arranged at the cylinder block 10a. Each intake port 15a extends from a side surface of the cylinder head 10b in a manner bending obliquely downward to the combustion chamber 14.

As illustrated in FIGS. 1 and 2, the intake apparatus 101 includes a surge tank 2a, plural (specifically, four in the present embodiment) intake pipes 2b, the intake air flow control valves 3 arranged at the respective intake pipes 2b, and an actuator 4 simultaneously rotating the plural intake air flow control valves 3. The intake apparatus 101 also includes intake passages 5 connected to the respective combustion chambers 14 of the engine 100 to supply intake air to the combustion chambers 14, and housing portions 6 provided at the respective intake passages 5 to house the intake air control valves 3.

The intake apparatus 101 includes swirl openings 7 that generates swirl serving as a first intake air flow within the respective combustion chambers 14 and tumble openings 8 that generate tumble serving as a second intake air flow within the respective combustion chambers 14. The swirl opening 7 and the tumble opening 8 serve as a first intake air flow generating opening and a second intake air flow generating opening, respectively.

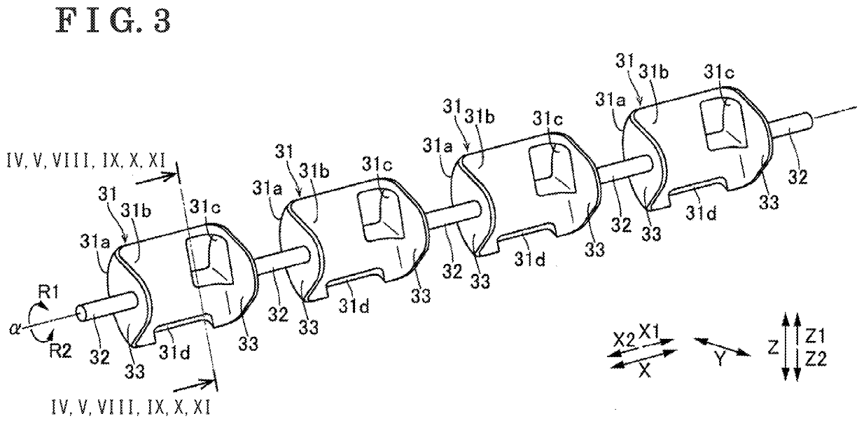

As illustrated in FIG. 3, each of the plural (four) intake air flow control valves 3 includes opposed rotary shafts 32 arranged at respective sides of the control valve 3 in the X direction. The plural intake air flow control valves 3 are connected to one another via the rotary shafts 32. Each intake air flow control valve 3 is arranged at the intake passage 5 to be rotatable relative to the rotary shafts 32. Each rotary shaft 32 is disposed at an intermediate position in a direction orthogonal to the X direction in a longitudinal section of the intake passage 5, i.e., at an intermediate position substantially in the Z direction.

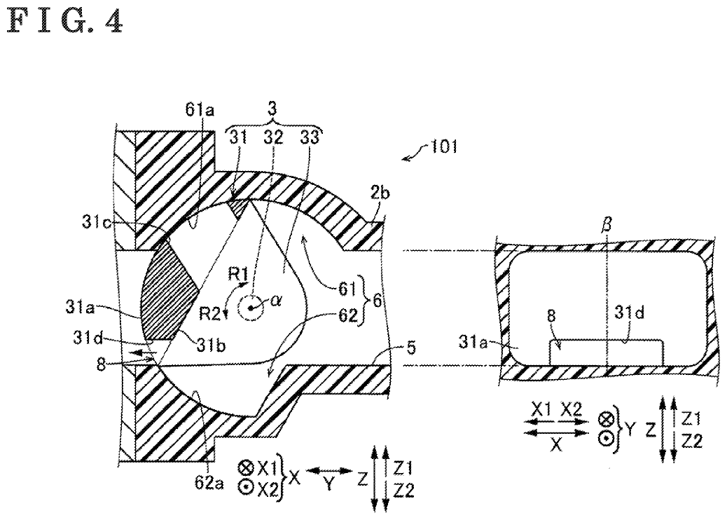

As illustrated in FIGS. 2 and 4, the intake apparatus 101 is configured to generate swirl and tumble by means of the swirl opening 7 and the tumble opening 8. The swirl opening 7 is arranged at the first side of the intake air flow control valve 3 in a rotating direction thereof. The tumble opening 8 is arranged at the second side of the intake air flow control valve 3 in the rotating direction thereof. Specifically, the swirl opening 7 is arranged at the R1 side (in the R1 direction) and the tumble opening 8 is arranged at the R2 side (in the R2 direction).

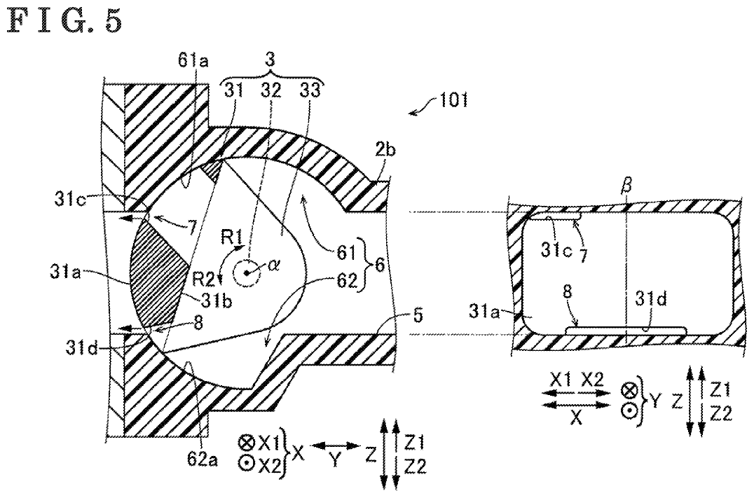

The intake apparatus 101 switches between three opening states by the rotation of each intake air flow control valve 3. The three opening states include a swirl state where the swirl opening 7 is opened at the R1 side of the intake air flow control valve 3, a tumble state where the tumble opening 8 is opened at the R2 side of the intake air flow control valve 3, and a swirl-tumble state (see FIG. 5) where the swirl opening 7 and the tumble opening 8 are both opened. The swirl state and the tumble state serve as a first intake air flow state and a second intake air flow state, respectively.

As illustrated in FIG. 2, the surge tank 2a is positioned at the upstream side of the plural intake pipes 2b. The surge tank 2a tentatively stores intake air so that the intake air equally flows to the plural intake pipes 2b.

The plural (four) intake pipes 2b extend and curve to the downstream side while surrounding the surge tank 2a to supply intake air from the surge tank 2a to the respective combustion chambers 14. The plural (four) intake pipes 2b are arranged in series in the X direction.

The single intake air flow control valve 3 is provided at each intake passage 5 (intake pipe 2). The intake air flow control valves 3 provided at the respective intake passages 5 (intake pipes 2) have identical configurations to one another. Each intake air flow control valve 3 controls a flow of intake air in the intake passage 5, which leads to generation of swirl and tumble within the combustion chamber 14. The intake air flow control valve 3 serves as a valve having functions of a tumble control valve (TCV) and a swirl control valve (SCV).

Each intake air flow control valve 3 includes a valve body 31, a pair of (first and second) rotary shafts 32 disposed at opposed ends of the valve body 31 (intake passage 5) in the X direction, and a pair of (first and second) connection portions 33 provided at opposed ends of the valve body 31 in the X direction as illustrated in FIG. 3.

The valve body 31 is supported to be rotatable by the rotary shafts 32 via the connection portions 33 and is configured to open and close the intake passage 5. The valve body 31 includes an external surface 31a and an internal surface 31b. The external surface 31a is formed by a curving surface including a protrusion and an arc with reference to a rotary axis line α of the rotary shaft 32. The internal surface 31b is formed by a linearly flat surface connecting opposed ends of the external surface 31a as viewed from the axial direction of the rotary shaft 32 (i.e., from the X direction).

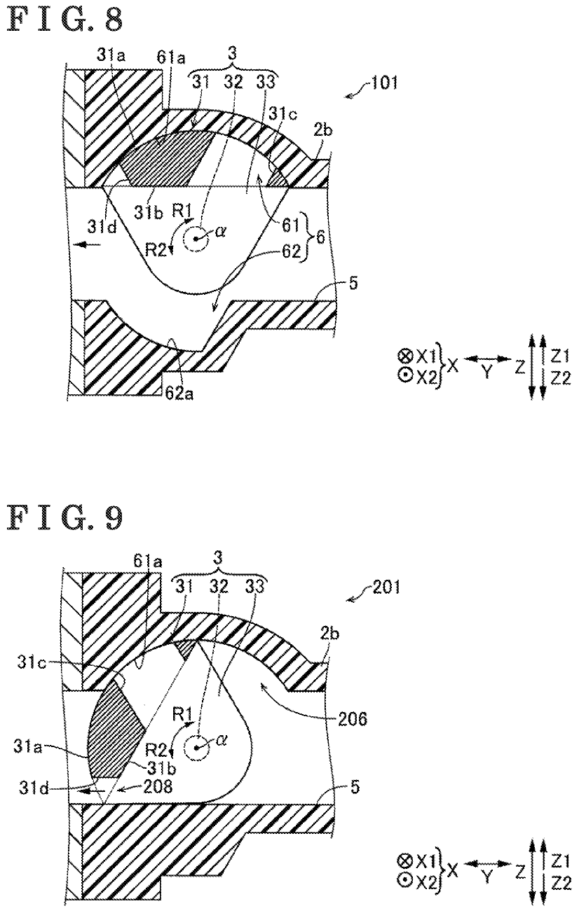

The internal surface 31b of the valve body 31 is arranged at a position dented relative to an inner surface of the intake passage 5 as illustrated in FIG. 8 in a state where the valve body 31 is fully housed in the housing portion 6 (specifically, housed in a first housing portion 61). That is, the internal surface 31b of the valve body 31 is inhibited from blocking or interfering with a flow of intake air within the intake passage 5 in a state where the valve body 31 is entirely housed in the housing portion 6 (first housing portion 61).

The valve body 31 includes a through-hole 31c constituting the swirl opening 7 at the first side of the intake air flow control valve 3 in the rotation direction thereof (i.e., at the R1 side). The valve body 31 also includes a cutout 31d constituting the tumble opening 8 at the second side of the intake air flow control valve 3 in the rotation direction thereof (i.e., at the R2 side).

The first and second connection portions 33 connect between the valve body 31 and the first and second rotary shafts 32. The first and second connection portions 33 are arranged at respective sides of the valve body 31 in the X direction within the intake passage 5. Each connection portion 33 is substantially formed in a triangular (or fan)-shaped plate extending in a direction orthogonal to the X direction.

The first and second connection portions 33 are housed in first and second accommodation portions 51 provided at the intake passage 5, the first and second accommodation portions 51 being opposed in the X direction. Specifically, the first and second accommodation portions 51 are dent portions arranged at one side in the X direction (i.e., at an X1 side) and the other side in the X direction (i.e., at an X2 side) respectively at the intake passage 5. The first and second connection portions 33 are configured not to interfere with or block the flow of intake air within the intake passage 5 in a state being housed in the first and second accommodation portions 51. The first and second connection portions 33 are constantly housed and arranged in the first and second accommodation portions 51.

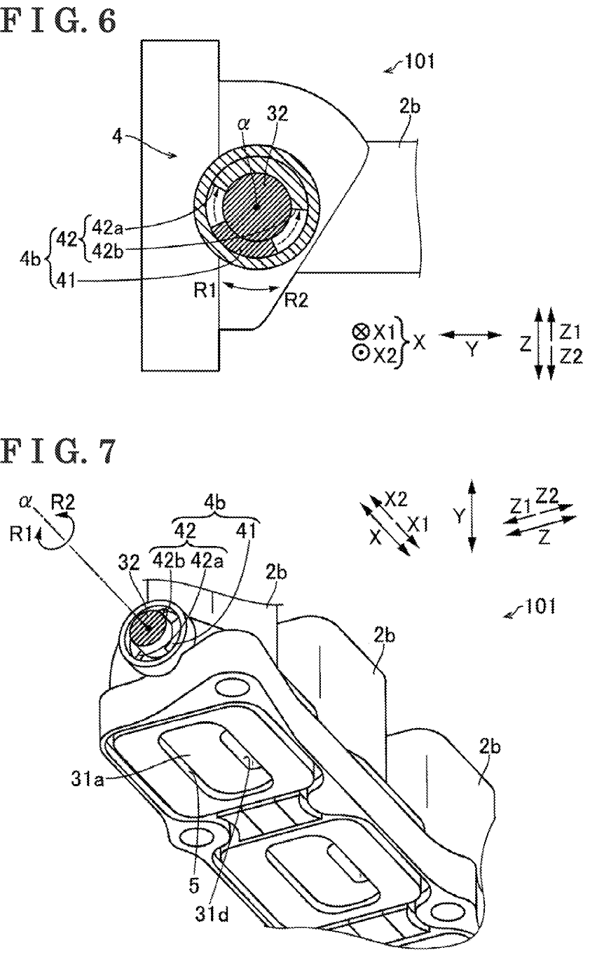

The single actuator 4 is provided at one end side (i.e., at an end in the X2 direction) of the rotary shafts 32 of the plural (four) intake air flow control valves 3 as illustrated in FIGS. 1, 6, and 7. The actuator 4 is configured to simultaneously rotate the plural (four) intake air flow control valves 3. The actuator 4 includes a drive portion 4a (see FIG. 1) that applies torque to the rotary shafts 32 (plural intake air flow control valves 3) and a rotation restriction portion 4b (see FIGS. 6 and 7) that restricts a rotation range of each intake air flow control valve 3 in the rotation direction thereof.

The rotation restriction portion 4b includes a rotary portion 41 rotating with the rotary shafts 32 and a stopper portion 42 that restricts the rotation of the rotary portion 41 by making contact therewith.

The stopper portion 42 includes a first stopper surface 42a provided at one side of the rotary portion 41 in the rotation direction thereof (i.e., at the R1 side) and a second stopper surface 42b provided at the other side of the rotary portion 41 in the rotation direction thereof (i.e., at the R2 side).

In a case where the rotary portion 41 rotates in the R1 direction to a position where the rotary portion 41 makes contact with the first stopper surface 42a (i.e., in a case where the intake air flow control valve 3 moves by its upward rotation), the valve body 31 is fully housed in the housing portion 6 (specifically, in the first housing portion 61) as illustrated in FIG. 8. Additionally, in a case where the rotary portion 41 rotates in the R2 direction to a position where the rotary portion 41 makes contact with the second stopper surface 42b (i.e., in a case where the intake air flow control valve 3 moves by its downward rotation), the valve body 31 is partially housed in the housing portion 6 (specifically, in a second housing portion 62).

As illustrated in FIG. 2, the intake passage 5 is a passage which is provided within the intake pipe 2b and through which intake air flows. The longitudinal section of the intake passage 5 has a round rectangular shape with a long side in the X direction and a short side in a direction substantially orthogonal to the Z direction.

The housing portion 60 is provided at the intake passage 5 to house the intake air flow control valve 3. The housing portion 60 includes the first housing portion 61 at an upper side (Z1 side) and the second housing portion 62 at a lower side (Z2 side).

The first housing portion 61 is provided at the inner surface of the intake passage 5 to be positioned at the first side (R1 side) of a rotation path of the intake air flow control valve 3. The first housing portion 61 is dent upward (i.e., in the Z1 direction). The first housing portion 61 is configured to fully house and accommodate the valve body 31 of the intake air flow control valve 3 as illustrated in FIG. 8. The first housing portion 61 includes a first inner surface (inner surface) 61a in a dent form and an arc form as viewed in the axial direction of the rotary shaft 32 (i.e., in the X direction).

In a state where the valve body 31 of the intake air flow control valve 3 is fully housed in the first housing portion 61, the curving external surface 31a of the valve body 31 is arranged close to the first inner surface 61a of the first housing portion 61 with substantially no clearance (with a slight clearance). The valve body 31 is inhibited from contacting the first inner surface 61a of the first housing portion 61 so as not to interfere with the rotation of the intake air flow control valve 3 (the valve body 31).

The second housing portion 62 is provided at the inner surface of the intake passage 5 to be positioned at the second side (R2 side) of the rotation path of the intake air flow control valve 3. The second housing portion 62 is dent downward (i.e., in the Z2 direction). The second housing portion 62 is configured to partially house and accommodate the valve body 31 of the intake air flow control valve 3. The second housing portion 62 includes a second inner surface (inner surface) 62a in a dent form and an arc form as viewed in the axial direction of the rotary shaft 32 (i.e., in the X direction). The size of the second inner surface 62a is smaller than the size of the first inner surface 61a. Specifically, the arc form of the second housing portion 62 corresponds to substantially a half of the first housing portion 61 at the downstream side thereof.

In a state where the valve body 31 of the intake air flow control valve 3 is housed in the second housing portion 62, the curving external surface 31a of the valve body 31 is arranged close to the second inner surface 62a of the second housing portion 62 with substantially no clearance (with a slight clearance). The valve body 31 is inhibited from contacting the second inner surface 62a of the second housing portion 62 so as not to interfere with the rotation of the intake air flow control valve 3 (the valve body 31).

As illustrated in FIG. 2, the swirl opening 7 is asymmetric with respect to a center line β of the intake air flow control valve 3 extending in a direction orthogonal to the rotary shaft 32. Specifically, the swirl opening 7 is constituted by the through-hole 31c provided at the first side of the intake air flow control valve 3 in the rotating direction thereof, i.e., at the R1 side of the intake air flow control valve 3. The through-hole 31c is positioned close to one side in the axial direction of the rotary shaft 32 (X direction) in the intake air flow control valve 3. The swirl opening 7 (through-hole 31c) extends in a direction orthogonal to a rotary axis line α of the rotary shaft 32 and penetrates through the valve body 31. The swirl opening 7 (through-hole 31c) is substantially in a rectangular form as viewed in the air flow direction.

As illustrated in FIG. 4, the tumble opening 8 is symmetric with respect to the center line β of the intake air flow control valve 3 extending in a direction orthogonal to the rotary shaft 32. Specifically, the tumble opening 8 is constituted by a clearance formed between the cutout 31d that is provided at the intake air flow control valve 3 (valve body 31) and the inner surface of the intake passage 5. The tumble opening 8 is provided at the second side of the intake air flow control valve 3 in the rotating direction thereof, i.e., at the R2 side of the intake air flow control valve 3. The tumble opening 8 is substantially in a rectangular form as viewed in the air flow direction. The tumble opening 8 includes a greater length (i.e., a wider form) than the swirl opening 7 in the X direction.

The switching between the swirl state and the tumble state is explained below. The swirl state, the tumble state, and the swirl-tumble state are switched therebetween by the actuator 4 that is driven and controlled by a predetermined controller. The predetermined controller may be an engine control unit (ECU) or an exclusive controller provided at the intake apparatus 101, for example.

The swirl state as illustrated in FIG. 2 is explained first. The intake apparatus 101 is brought into the swirl state in a case where each intake air flow control valve 3 is rotated to the second side in the rotation direction thereof (to the R2 side) to release the state where the swirl opening 7 is closed by the first housing portion 61 (the upper housing portion). The swirl opening 7 is provided at the first side of the intake air flow control valve 3 in the rotation direction thereof (i.e., at the R1 side corresponding to the upper side). The swirl opening 7 is maximized in a state where the rotary portion 41 of the actuator 4 makes contact with the second stopper surface 42b. Additionally, the swirl opening 7 is gradually smaller while the intake air flow control valve 3 is rotating to the first side (R1 side) from the position where the rotary portion 41 is in contact with the second stopper surface 42b (i.e., a downward rotation restriction position).

The intake apparatus 101 is then brought into the swirl-tumble state as illustrated in FIG. 5 in a case where the intake air flow control valve 3 is rotated to the first side in the rotation direction thereof (to the R1 side) from the swirl state so that the state where the tumble opening 8 is closed by the second housing portion 62 is released. The tumble opening 8 is provided at the second side of the intake air flow control valve 3 in the rotation direction thereof (i.e., at the R2 side corresponding to the lower side). Specifically, the tumble opening 8 is independently provided or formed from the swirl opening 7 and is arranged at an opposite position thereto in the rotation direction of the intake air flow control valve 3. The tumble opening 8 is thus positioned away from the swirl opening 7.

The intake apparatus 101 is brought into the tumble state as illustrated in FIG. 4 in a case where the intake air flow control valve 3 is further rotated to the R1 side from the swirl-tumble state so that the swirl opening 7 is closed by the first housing portion 61.

The intake apparatus 101 is brought to a state as illustrated in FIG. 8 where the valve body 31 of the intake air flow control valve 3 is fully housed in the first housing portion 61 in a case where the intake air flow control valve 3 is further rotated to the R1 side from the tumble state. Specifically, the intake apparatus 101 is brought to a state where neither swirl nor tumble is generated at the combustion chamber 14. The intake apparatus 101 is configured to switch between the swirl state and the tumble state while the valve body 31 of the intake air flow control valve 3 is being positioned at the downstream side of the rotary shaft 32.

The intake apparatus 101 is configured to switch between the swirl state and the tumble state depending on a driving state of the engine 100. For example, the intake apparatus 101 generates strong swirl at startup of the engine 100. The intake apparatus 101 controls strength of tumble depending on speed and load of the engine 100 to improve fuel consumption at idling or steady driving state of the engine 100. The intake apparatus 101 is configured to fully open the intake passage 5 by housing the intake air flow control valve 3 to increase intake air volume to generate output (torque) at acceleration or high-speed driving state. The intake apparatus 101 is configured to generate weak swirl to reduce particulate matter (PM) at a transition state of the engine 100 from the steady driving state to the acceleration state.

According to the first embodiment, the swirl opening 7 and the tumble opening 8 are provided at the first side and the second side of the intake air flow control valve 3 in the rotation direction thereof. The intake air flow control valve 3 rotates to be switchable between the swirl state where the swirl opening 7 is opened at the first side of the intake air flow control valve 3 in the rotation direction thereof and the tumble state where the tumble opening 8 is opened at the second side of the intake air flow control valve 3 in the rotation direction thereof. Being different from a known apparatus where swirl (lateral vortex) and tumble (vertical vortex) are both generated at the same side of the intake air flow control valve in the rotation direction thereof, swirl and tumble are generated independently at different sides from each other of the intake air flow control valve 3 in the rotation direction thereof. Specifically, being different from a known apparatus where swirl and tumble are generated at adjacent positions so as to interact with each other, swirl and tumble are generated independently at separated positions from each other, which leads to generation of pure swirl and tumble.

The swirl opening 7 and the tumble opening 8 are respectively asymmetric and symmetric with respect to the center line β of the intake air flow control valve 3 extending in the direction orthogonal to the rotary shaft 32. The intake air which flows through the swirl opening 7 that is asymmetric relative to the center line β is effectively rotatable laterally within the combustion chamber 14, which leads to generation of pure swirl. Additionally, the intake air which flows through the tumble opening 8 that is symmetric relative to the center line β is effectively rotatable vertically within the combustion chamber 14, which leads to generation of pure tumble.

In the first embodiment, the swirl opening 7 is constituted by the through-hole 31c formed at the intake air flow control valve 3 in a state being closer to one side than the other side in the axial direction (i.e., close to one axial side) of the rotary shaft 32. The swirl opening 7 is provided at the first side of the intake air flow control valve 3 in the rotation direction thereof. The tumble opening 8 is constituted by the clearance between the cutout 31d formed at the intake air flow control valve 3 and the inner surface of the intake passage 5. The tumble opening 8 is provided at the second side of the intake air flow control valve 3 in the rotation direction thereof. The mechanical strength of the intake air flow control valve 3 is ensured in a state where the entire edge (periphery) of the swirl opening 7 is formed by the intake air flow control valve 3, compared to a case where the asymmetric swirl opening 7 with respect to the center line β is constituted by the cutout 31d. Additionally, the tumble opening 8 that is symmetric with respect to the center line β and is constituted by the clearance between the cutout 31d of the intake air flow control valve 3 and the inner surface of the intake passage 5 achieves the intake air flowing and passing through a closer position to the inner surface of the intake passage 5. Further pure tumble may be generated by the intake air that effectively rotates vertically within the combustion chamber 14.

The housing portion 6 includes the first housing portion 61 in a recess form and the second housing portion 62 in a recess form. The first housing portion 61 is provided at the inner surface of the intake passage 5 and positioned at the first side of the rotation path of the intake air flow control valve 3, and the second housing portion 62 is provided at the inner surface of the intake passage 5 and positioned at the second side of the rotation path of the intake air flow control valve 3. The opening size of each of the swirl opening 7 and the tumble opening 8 is changeable at the first side or the second side of the intake air flow control valve 3 in the rotation direction thereof, by changing the amount by which the intake air flow control valve 3 is housed in each of the first housing portion 61 and the second housing portion 62. The strength of swirl and tumble is changeable accordingly.

The intake air flow control valve 3 includes the valve body 31 rotatably supported at the rotary shafts 32 and selectively opening and closing the intake passage 5. The first housing portion 61 is configured to entirely house the valve body 31 and the second housing portion 62 is configured to partially house the valve body 31. The valve body 31 is thus inhibited from interfering with the flow of intake air while being fully housed in the first housing portion 61. Additionally, the second housing portion 62 where the valve body 31 is configured to be partially housed is formed smaller than the first housing portion 61, which restrains the second housing portion 62 from interfering with the flow of intake air.

The intake air flow control valve 3 rotates to switch between the swirl state, the tumble state, and the swirl-tumble state where the swirl opening 7 and the tumble opening 8 are opened at the same time. Not only pure swirl and pure tumble are generated but also swirl and tumble are both generated simultaneously, which leads to flexible control of the flow of intake air depending on various driving conditions of the internal combustion engine.

The intake air flow control valve 3 includes a pair of (first and second) rotary shafts 32 provided at the opposed sides in the intake passage 5, the valve body 31 opening and closing the intake passage 5, and a pair of (first and second) connection portions 33 connecting between the valve body 31 and each of the rotary shafts 32. The housing portion 6 (the first housing portion 61) is configured to entirely house the valve body 31 so that the valve body 31 is restrained from blocking or interfering with the flow of intake air. The connection between the valve body 31 and the rotary shafts 32 by the connection portions 33 achieves arrangement of the valve body 31 (i.e., the plural valve bodies 31) along the inner surface of the intake passage 5 that is positioned in the direction orthogonal to the rotary shafts 32.

The first and second accommodation portions 51 are provided at the intake passage 5 to accommodate the first and second connection portions 33. The connection portions 33 are thus inhibited from blocking or interfering with the flow of intake air.

The valve body 31 includes the external surface 31a that is formed by a curving surface including a protrusion and an arc with reference to the rotary axis line of the rotary shaft 32 as viewed in the axial direction of the rotary shaft 32 and the internal surface 31b that is formed by a linearly flat surface connecting the opposed ends of the external surface 31a as viewed in the axial direction of the rotary shaft 32. The housing portion 6 includes the inner surface in a dent form and an arc form as viewed in the axial direction of the rotary shaft 32 and extending along the external surface of the valve body 31. The valve body 31 is arranged within the housing portion 6 with substantially no clearance, which inhibits the intake air from flowing through between the valve body 31 and the housing portion 6. Specifically, the intake air is inhibited from being interfered in a state where the valve body 31 is housed in the housing portion 6.

The internal surface 31b of the valve body 31 is arranged at a further concave position than the inner surface of the intake passage 5 in a state where the valve body 31 is fully housed in the housing portion 6. The valve body 31 is thus inhibited from protruding within the intake passage 5 in a state where the valve body 31 is fully housed in the housing portion 6. The intake air is inhibited from being interfered by the valve body 31.

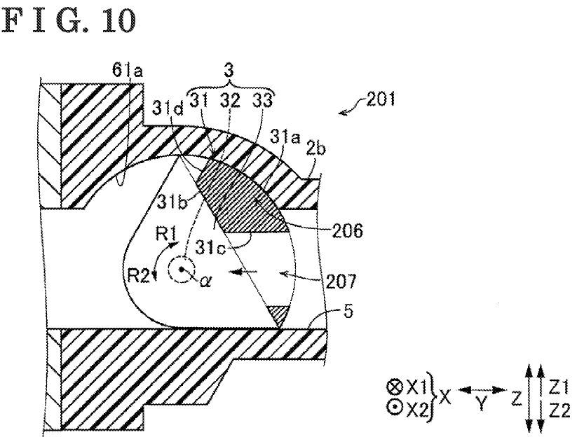

A second embodiment is explained with reference to FIGS. 1, 9 and 10. In the first embodiment, the swirl state and the tumble state are switched therebetween in a state where the valve body 31 of the intake air flow control valve 3 is positioned at the downstream side of the rotary shafts 32. In the second embodiment, the swirl state and the tumble state are switchable in a case where the valve body 31 of the intake air flow control valve 3 is positioned at the upstream side and at the downstream side of the rotary shafts 32. In FIGS. 9 and 10, the same reference numerals are employed for components similar to those of the first embodiment.

As illustrated in FIGS. 9 and 10, an air intake apparatus (intake apparatus) 201 of the second embodiment includes an actuator 204 (see FIG. 1) that simultaneously rotates the plural (four) intake air flow control valves 3, and housing portions 206 provided at the respective intake passages 5 to house the intake air flow control valves 3. The intake apparatus 201 includes swirl openings 207 generating swirl within the respective combustion chambers 14 and tumble openings 208 generating tumble within the respective combustion chambers 14. The swirl opening 207 and the tumble opening 208 serve as the first intake air flow generating opening and the second intake air flow generating opening, respectively.

The actuator 204 is configured to rotate each intake air flow control valve 3 in a wider range at the first side (R1 side) in the rotation direction of the control valve 3 as compared to the actuator 4 of the first embodiment. Specifically, the valve body 31 of the intake air flow control valve 3 is movable to the upstream side of the rotary shafts 32 in addition to the downstream side thereof.

As illustrated in FIG. 10, the actuator 204 is configured to move the intake air flow control valve 3 to the first side in the rotation direction thereof (R1 side) so that the valve body 31 (specifically, an end portion of the valve body 31 at the R1 side) substantially makes contact with the lower inner surface of the intake passage 5. The swirl opening 207 is arranged at the upstream side of the rotary shaft 32 in a state where the valve body 31 is positioned at the upstream side of the rotary shaft 32.

As illustrated in FIG. 9, the actuator 204 is configured to move the intake air flow control valve 3 to the second side in the rotation direction thereof (R2 side) so that the valve body 31 (specifically, an end portion of the valve body 31 at the R2 side) substantially makes contact with the lower inner surface of the intake passage 5. The tumble opening 208 is arranged at the downstream side in a state where the valve body 31 is positioned at the downstream side of the rotary shaft 32.

The housing portion 206 is constituted by the first housing portion having the similar construction to the first housing portion 61 of the first embodiment. The housing portion 206 does not include a construction corresponding to the second housing portion 62 of the first embodiment.

The other configurations of the second embodiment are similar to the first embodiment.

According to the second embodiment, in the same manner as the first embodiment, the intake air flow control valve 3 is rotated in a state where the swirl opening 7 is provided at the first side and the tumble opening 8 is provided at the second side in the rotation direction of the intake air flow control valve 3. The swirl state where the swirl opening 7 is opened at the first side in the rotation direction of the intake air flow control valve 3 and the tumble state where the tumble opening 8 is opened at the second side in the rotation direction of the intake air flow control valve 3 are switchable therebetween, which leads to generation of pure swirl and tumble accordingly.

The intake air flow control valve 3 includes the valve body 31 rotatably supported at the rotary shafts 32 and configured to open and close the intake passage 5, the valve body 31 being movable to the upstream side and the downstream side of the rotary shafts 32. One of the swirl opening 7 and the tumble opening 8 is arranged at the downstream side of the rotary shaft 32 when the valve body 31 is positioned at the downstream side of the rotary shaft 32 and the other of the swirl opening 7 and the tumble opening 8 is arranged at the upstream side when the valve body 31 is positioned at the upstream side of the rotary shaft 32. The swirl state and the tumble state are thus switchable by rotating the intake air flow control valve 3 to the first side or the second side of the air flow control valve 3 in the rotation direction thereof from a state where the intake air flow control valve 3 is housed in the housing portion 6. The switching to the swirl state or to the tumble state is thus promptly performed from the state where the intake air flow control valve 3 is housed in the housing portion 6.

The other effects of the second embodiment are similar to the first embodiment.

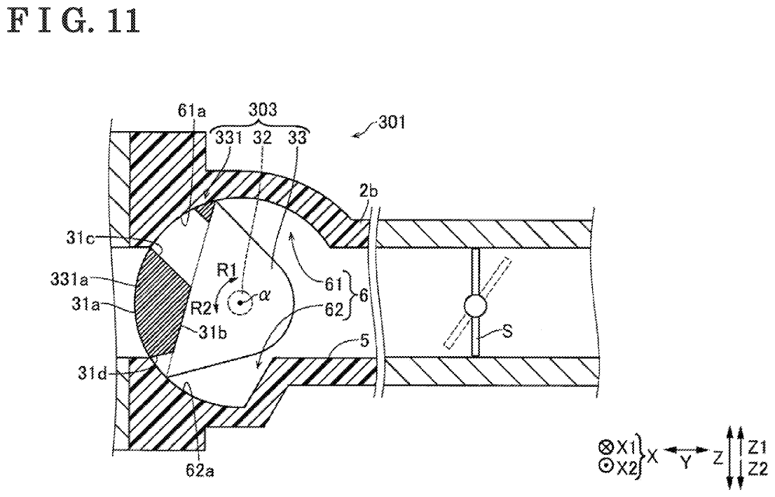

A third embodiment is explained with reference to FIG. 11. Being different from the first embodiment, the intake passage 5 is configured to be fully closed by an intake air flow control valve 303. In FIG. 11, the same reference numerals are employed for components similar to those of the first embodiment.

As illustrated in FIG. 11, an air intake apparatus (intake apparatus) 301 includes the intake air flow control valve 303 including a valve body 331.

The intake air flow control valve 303 includes a full-close portion 331a configured to fully close the intake passage 5. The full-close portion 331a is provided between the swirl opening 7 (see FIG. 2) and the tumble opening 8 (see FIG. 4) in the rotation direction (R direction) of the intake air flow control valve 303. Specifically, the full-close portion 331a is arranged between the through-hole 31c constituting the swirl opening 7 and the cutout 31d constituting the tumble opening 8 in the rotation direction (R direction) of the intake air flow control valve 303. The full-close portion 331a is a part of the valve body 331.

The intake apparatus 301 is configured to fully close the intake passage 5 with the full-close portion 331a by rotating the intake air flow control valve 303 at the same timing as timing at which a throttle valve S closes the intake passage 5.

The other configurations of the third embodiment are similar to the first embodiment.

According to the third embodiment, in the same manner as the first embodiment, the intake air flow control valve 303 is rotated in a state where the swirl opening 7 is provided at the first side and the tumble opening 8 is provided at the second side in the rotation direction of the intake air flow control valve 303. The swirl state where the swirl opening 7 is opened at the first side in the rotation direction of the intake air flow control valve 303 and the tumble state where the tumble opening 8 is opened at the second side in the rotation direction of the intake air flow control valve 303 are switchable therebetween, which leads to generation of pure swirl and tumble accordingly.

The intake air flow control valve 303 includes the full-close portion 331a provided between the swirl opening 7 and the tumble opening 8 to fully close the intake passage 5. The intake air flowing through the intake passage 5 may be thus blocked by the full-close portion 331a depending on the driving condition of the engine.

The intake passage 5 is fully closed at the same timing as the timing at which the intake passage 5 is fully closed by the throttle valve S. The intake air flowing through the intake passage 5 is thus blocked by the full-close portion 331a at the same timing as the timing at which the intake passage 5 is fully closed by the throttle valve S, which may overcome response delay upon decrease of intake air by the throttle valve S.

The other effects of the third embodiment are similar to the first embodiment.

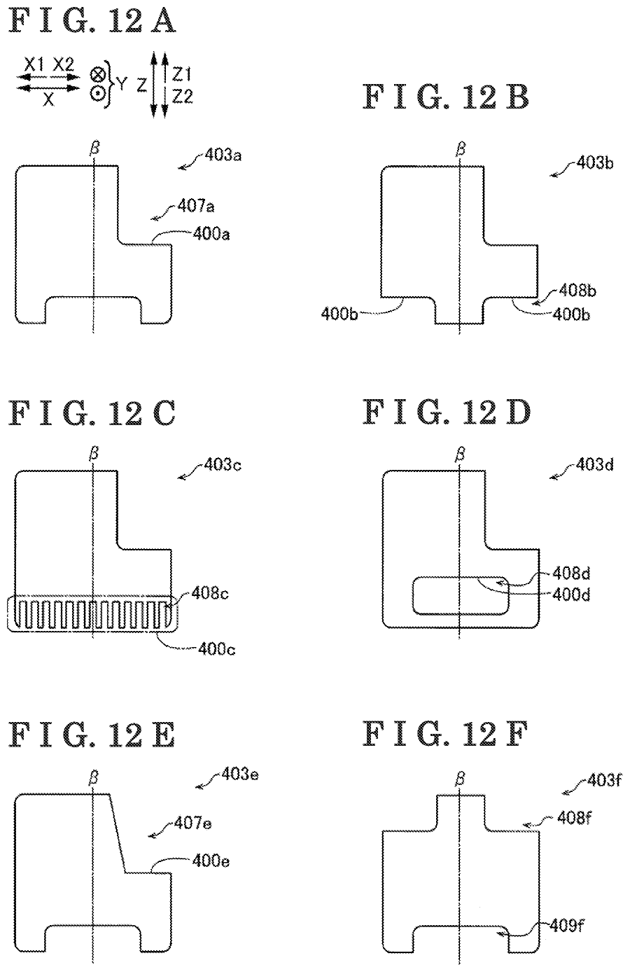

The embodiments are not limited to include the aforementioned configurations and may be appropriately modified or changed. Modified examples are explained with reference to FIGS. 12A to 12F. The directions X, Y, and Z in FIG. 12A are also applied to FIGS. 12B to 12F.

The swirl opening is constituted by the through-hole 31c according to the first to third embodiments. Alternatively, an intake air flow control valve 403a as illustrated in FIG. 12A may include a cutout 400a. A swirl opening 407a may be a portion formed between the cutout 400a and the inner surface of the intake passage.

The tumble opening is constituted by the single cutout according to the first to third embodiments. Alternatively, an intake air flow control valve 403b as illustrated in FIG. 12B may include a pair of cutouts 400b that constitutes a tumble opening 408b. Additionally, an intake air flow control valve 403c as illustrated in FIG. 12C may include a pectinate cutout 400c that constitutes a tumble opening 408c.

The tumble opening is constituted by the cutout according to the first to third embodiments. Alternatively, an intake air flow control valve 403d as illustrated in FIG. 12D may include a through-hole 400d that constitutes a tumble opening 408d.

The swirl opening is constituted by the through-hole with the edge extending in the X direction and the Z direction according to the first to third embodiments. Alternatively, an intake air flow control valve 403e as illustrated in FIG. 12E may include a cutout 400e with an edge that inclines in the X direction and the Z direction to constitute a swirl opening 407e. The tumble opening may be constituted in the same manner.

The swirl opening and the tumble opening are respectively provided at one side and the other side in the rotation direction of the intake air flow control valve according to the first to third embodiments. Alternatively, an intake air flow control valve 403f as illustrated in FIG. 12F may include a tumble opening 408f at one side and another tumble opening 409f at the other side in the rotation direction of the intake air flow control valve 403f.

The intake passage according to the first to third embodiments includes a longitudinal section in a rectangular shape. Alternatively, the intake passage may include a longitudinal section in a shape other than the rectangular shape, such as a truck shape, for example.

The engine serves as an inline four-cylinder engine according to the first to third embodiments. Alternatively, the engine may be a single-cylinder engine or an inline two, three, five, or more than five-cylinder engine.

The tumble opening is provided at the closer position to the combustion chamber and the swirl opening is provided at the farther position from the combustion chamber according to the first to third embodiments. Alternatively, the swirl opening may be provided at the closer position to the combustion chamber and the tumble opening may be provided at the farther position from the combustion chamber.

The rotary shaft is arranged at substantially the center position of the intake passage in the direction orthogonal to the X direction (where the rotary shaft extends) of the longitudinal section of the intake passage (i.e., in substantially the Z direction) according to the first to third embodiments. Alternatively, the rotary shaft may be arranged at a position out of the center position of the intake passage in the direction orthogonal to the X direction (where the rotary shaft extends) of the longitudinal section of the intake passage (i.e., in substantially the Z direction).

The housing portion that entirely houses the valve body is provided at a farther side (i.e., at the Z1 side of the intake passage) from the combustion chamber according to the first to third embodiments. Alternatively, the housing portion that entirely houses the valve body may be provided at a closer side to the combustion chamber (i.e., at the Z2 side of the intake passage).

The plural intake air flow control valves are integrally rotated by the single actuator according to the first to third embodiments. Alternatively, the plural intake air flow control valves may be driven and rotated individually by plural actuators.

According to the first to third embodiments, an air intake apparatus 101, 201, 301 of an internal combustion engine 100 includes an intake passage 5 connected to a combustion chamber 14 of the internal combustion engine 100 to supply an intake air to the combustion chamber 14, an intake air flow control valve 3, 303 including a rotary shaft 32 and provided at the intake passage 5 to be rotatable to the rotary shaft 32, the intake air flow control valve 3, 303 controlling a flow of intake air, a housing portion 6, 206 provided at the intake passage 5 and configured to house the intake air flow control valve 3, 303, a swirl opening 7, 207 arranged at a first side in a rotation direction of the intake air flow control valve 3, 303 to generate swirl within the combustion chamber 14, and a tumble opening 8, 208 arranged at a second side in the rotation direction of the intake air flow control valve 3, 303 to generate tumble within the combustion chamber 14. The swirl opening 7, 207 is provided at one of the intake air flow control valve 3, 303 and a portion between an inner surface of the intake passage 5 and the intake air flow control valve 3, 303, the tumble opening 8, 208 being provided at the other of the intake air flow control valve 3, 303 and the portion between the inner surface of the intake passage 5 and the intake air flow control valve 3, 303. The intake air flow control valve 3, 303 rotates to achieve a switching between a swirl state where the swirl opening 7, 207 is opened at the first side in the rotation direction of the intake air flow control valve 3, 303 and a tumble state where the tumble opening 8, 208 is opened at the second side in the rotation direction of the intake air flow control valve 3, 303.

The swirl opening 7, 207 includes a configuration asymmetric to a center line β of the intake air flow control valve 3, 303 in an axial direction of the rotation shaft 32, the center line β extending in a direction orthogonal to the rotation shaft 32. The tumble opening 8, 208 includes a configuration symmetric to the center line β of the intake air flow control valve 3, 303 in the axial direction of the rotation shaft 32.

The swirl opening 7, 207 is constituted by a through-hole 31c provided at the intake air flow control valve 3, 303, the through-hole 31c being positioned closer to one side than the other side in the axial direction of the rotary shaft 32 in a state being arranged at the first side in the rotation direction of the intake air flow control valve 3, 303. The tumble opening 8, 208 is constituted by a clearance between a cutout 31d provided at the intake air flow control valve 3, 303 and the inner surface of the intake passage 5 at the second side in the rotation direction of the intake air flow control valve 3, 303.

The housing portion 6 includes a first housing portion 61 in a dent form provided at the inner surface of the intake passage 5 and positioned at one side in a rotation path of the intake air flow control valve 3, 303 and a second housing portion 62 in a dent form provided at the inner surface of the intake passage 5 and positioned at the other side in the rotation path of the intake air flow control valve 3, 303.

The intake air flow control valve 3, 303 includes a valve body 31, 331 rotatably supported at the rotary shaft 32 and configured to open and close the intake passage 5. The first housing 61 is configured to fully house the valve body 31, 331. The second housing 62 is configured to partially house the valve body 31, 331.

According to the second embodiment, the intake air flow control valve 3 includes a valve body 31 rotatably supported at the rotary shaft 32 and configured to open and close the intake passage 5. The valve body 31 is movable to an upstream side and a downstream side of the rotary shaft 32. One of the swirl opening 207 and the tumble opening 208 is provided at the downstream side of the rotary shaft 32 in a case where the valve body 31 is positioned at the downstream side of the rotary shaft 32. The other of the swirl opening 207 and the tumble opening 208 is provided at the upstream side of the rotary shaft 32 in a case where the valve body 31 is positioned at the upstream side of the rotary shaft 32 in a case where the valve body 31 is positioned at the downstream side of the rotary shaft 32.

According to the third embodiment, the intake air flow control valve 303 includes a full-close portion 331a provided between the swirl opening 7 and the tumble opening 8 to fully close the intake passage.

The full-close portion 331a fully closes the intake passage 5 at the same timing as timing at which the intake passage 5 is fully closed by a throttle valve S arranged within the intake passage 5.

According to the first to third embodiments, the intake air flow control valve 3, 303 rotates to achieve a switching between the swirl state, the tumble state, and a swirl-tumble state where the swirl opening 7, 207 and the tumble opening 8, 208 are simultaneously opened.

The swirl opening 7, 207 is constituted by one of a through-hole 31c provided at the intake air flow control valve 3, 303 and a clearance between a cutout 31d provided at the intake air flow control valve 3, 303 and the inner surface of the intake passage 5, the swirl opening 7, 207 being positioned closer to one side than the other side in the axial direction of the rotary shaft 32 in a state being arranged at the first side in the rotation direction of the intake air flow control valve 3, 303.

The swirl opening formed with various kinds of configurations may be thus provided at the intake air flow control valve to obtain appropriate swirl for various types of internal combustion engines.

The tumble opening 8, 208 is constituted by one of a through-hole 31c, a first clearance, and a second clearance provided at the second side in the rotation direction of the intake air flow control valve 3, 303, the through-hole 31c being provided at the intake air flow control valve 3, 303, the first clearance being formed between a cutout provided at the intake air flow control valve 3, 303 and the inner surface of the intake passage 5, the second clearance being formed between an end surface of the intake air flow control valve 3, 303 and the inner surface of the intake passage 5.

The tumble opening formed with various kinds of configurations may be thus provided at the intake air flow control valve to obtain appropriate tumble for various types of internal combustion engines.

The rotary shaft 32 of the intake air flow control valve 3, 303 includes first and second rotary shafts 32 provided at opposed sides in the intake passage 5. The intake air flow control valve 3, 303 includes a valve body 31, 331 configured to open and close the intake passage 5, and first and second connection portions 33 connecting the valve body 31, 331 and the first and second rotary shafts 32. The housing portion 6 is configured to fully house the valve body 31, 331.

The air intake apparatus 101, 201, 301 further includes first and second accommodation portions 51 accommodating the first and second connection portions 33 of the intake air flow control valve 3, 303.

The valve body 31, 331 includes an external surface 31a forming a curving surface in a protrusion form and an arc form with reference to a rotation axis line α of the rotary shaft 32 as viewed in an axial direction of the rotary shaft 32, and an internal surface 31b forming a linearly flat surface connecting respective ends of the external surface 31a as viewed in the axial direction. The housing portion 6 includes an inner surface in a recess form and an arc form extending along the external surface 31a of the valve body 31, 331 as viewed in the axial direction.

The internal surface 31b of the valve body 31, 331 is arranged at a further concave position than the inner surface of the intake passage 5 in a state where the valve body 31, 331 is fully housed in the housing portion 6.

According to the first to third embodiments, an air intake apparatus 101, 201, 301 of an internal combustion engine 100 includes an intake passage 5 connected to a combustion chamber 14 of the internal combustion engine 100 to supply an intake air to the combustion chamber 14, an intake air flow control valve 3, 303 including a rotary shaft 32 and provided at the intake passage 5 to be rotatable to the rotary shaft 32, the intake air flow control valve 3, 303 controlling a flow of intake air, a housing portion 6, 206 provided at the intake passage 5 and configured to house the intake air flow control valve 3, 303, a swirl opening 7, 207 (first intake air flow generating opening) arranged at a first side in a rotation direction of the intake air flow control valve 3, 303 to generate swirl (first intake air flow) within the combustion chamber 14, and a tumble opening 8, 208 (second intake air flow generating opening) arranged at a second side in the rotation direction of the intake air flow control valve 3, 303 to generate tumble (second intake air flow) within the combustion chamber 14. The first intake air flow generating opening 7, 207 being provided at one of the intake air flow control valve 3, 303 and a portion between an inner surface of the intake passage 5 and the intake air flow control valve 3, 303, the second intake air flow generating opening 8, 208 being provided at the other of the intake air flow control valve 3, 303 and the portion between the inner surface of the intake passage 5 and the intake air flow control valve 3, 303.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An air intake apparatus of an internal combustion engine, the air intake apparatus comprising:
an intake passage connected to a combustion chamber of the internal combustion engine to supply an intake air to the combustion chamber;
an intake air flow control valve including a rotary shaft and provided at the intake passage to be rotatable to the rotary shaft, the intake air flow control valve controlling a flow of intake air;
a housing portion provided at the intake passage and configured to house the intake air flow control valve;
a swirl opening arranged at a first side in a rotation direction of the intake air flow control valve to generate swirl within the combustion chamber; and
a tumble opening arranged at a second side in the rotation direction of the intake air flow control valve to generate tumble within the combustion chamber,
the swirl opening being provided at one of the intake air flow control valve and a portion between an inner surface of the intake passage and the intake air flow control valve, the tumble opening being provided at the other of the intake air flow control valve and the portion between the inner surface of the intake passage and the intake air flow control valve,
the intake air flow control valve rotating to achieve a switching between a swirl state where the swirl opening is opened at the first side in the rotation direction of the intake air flow control valve and a tumble state where the tumble opening is opened at the second side in the rotation direction of the intake air flow control valve.

2. The air intake apparatus according to claim 1, wherein
the swirl opening includes a configuration asymmetric to a center line of the intake air flow control valve in an axial direction of the rotation shaft, the center line extending in a direction orthogonal to the rotation shaft,
the tumble opening includes a configuration symmetric to the center line of the intake air flow control valve in the axial direction of the rotation shaft.

3. The air intake apparatus according to claim 2, wherein
the swirl opening is constituted by a through-hole provided at the intake air flow control valve, the through-hole being positioned closer to one side than the other side in the axial direction of the rotary shaft in a state being arranged at the first side in the rotation direction of the intake air flow control valve,
the tumble opening is constituted by a clearance between a cutout provided at the intake air flow control valve and the inner surface of the intake passage at the second side in the rotation direction of the intake air flow control valve.

4. The air intake apparatus according to claim 1, wherein the housing portion includes a first housing portion in a dent form provided at the inner surface of the intake passage and positioned at one side in a rotation path of the intake air flow control valve and a second housing portion in a dent form provided at the inner surface of the intake passage and positioned at the other side in the rotation path of the intake air flow control valve.

5. The air intake apparatus according to claim 4, wherein
the intake air flow control valve includes a valve body rotatably supported at the rotary shaft and configured to open and close the intake passage,
the first housing is configured to fully house the valve body,
the second housing is configured to partially house the valve body.

6. The air intake apparatus according to claim 1, wherein
the intake air flow control valve includes a valve body rotatably supported at the rotary shaft and configured to open and close the intake passage,
the valve body is movable to an upstream side and a downstream side of the rotary shaft,
one of the swirl opening and the tumble opening is provided at the downstream side of the rotary shaft in a case where the valve body is positioned at the downstream side of the rotary shaft,
the other of the swirl opening and the tumble opening is provided at the upstream side of the rotary shaft in a case where the valve body is positioned at the upstream side of the rotary shaft.

7. The air intake apparatus according to claim 1, wherein the intake air flow control valve includes a full-close portion provided between the swirl opening and the tumble opening to fully close the intake passage.

8. The air intake apparatus according to claim 7, wherein the full-close portion fully closes the intake passage at the same timing as timing at which the intake passage is fully closed by a throttle valve arranged within the intake passage.

9. The air intake apparatus according to claim 1, wherein the intake air flow control valve rotates to achieve a switching between the swirl state, the tumble state, and a swirl-tumble state where the swirl opening and the tumble opening are simultaneously opened.

10. The air intake apparatus according to claim 2, wherein the swirl opening is constituted by one of a through-hole provided at the intake air flow control valve and a clearance between a cutout provided at the intake air flow control valve and the inner surface of the intake passage, the swirl opening being positioned closer to one side than the other side in the axial direction of the rotary shaft in a state being arranged at the first side in the rotation direction of the intake air flow control valve.

11. The air intake apparatus according to claim 2, wherein the tumble opening is constituted by one of a through-hole, a first clearance, and a second clearance provided at the second side in the rotation direction of the intake air flow control valve, the through-hole being provided at the intake air flow control valve, the first clearance being formed between a cutout provided at the intake air flow control valve and the inner surface of the intake passage, the second clearance being formed between an end surface of the intake air flow control valve and the inner surface of the intake passage.

12. The air intake apparatus according to claim 1, wherein
the rotary shaft of the intake air flow control valve includes first and second rotary shafts provided at opposed sides in the intake passage,
the intake air flow control valve includes a valve body configured to open and close the intake passage, and first and second connection portions connecting the valve body and the first and second rotary shafts,
the housing portion is configured to fully house the valve body.

13. The air intake apparatus according to claim 12, further comprising first and second accommodation portions accommodating the first and second connection portions of the intake air flow control valve.

14. The air intake apparatus according to claim 13, wherein
the valve body includes an external surface forming a curving surface in a protrusion form and an arc form with reference to a rotation axis line of the rotary shaft as viewed in an axial direction of the rotary shaft, and an internal surface forming a linearly flat surface connecting respective ends of the external surface as viewed in the axial direction,
the housing portion includes an inner surface in a recess form and an arc form extending along the external surface of the valve body as viewed in the axial direction.

15. The air intake apparatus according to claim 14, wherein the internal surface of the valve body is arranged at a further concave position than the inner surface of the intake passage in a state where the valve body is fully housed in the housing portion.

16. An air intake apparatus of an internal combustion engine, the air intake apparatus comprising;
an intake passage connected to a combustion chamber of the internal combustion engine to supply an intake air to the combustion chamber;
an intake air flow control valve including a rotary shaft and provided at the intake passage to be rotatable to the rotary shaft, the intake air flow control valve controlling a flow of intake air;
a housing portion provided at the intake passage and configured to house the intake air flow control valve;
a first intake air flow generating opening arranged at a first side in a rotation direction of the intake air flow control valve to generate a first intake air flow within the combustion chamber; and
a second intake air flow generating opening arranged at a second side in the rotation direction of the intake air flow control valve to generate a second intake air flow within the combustion chamber,
the first intake air flow generating opening being provided at one of the intake air flow control valve and a portion between an inner surface of the intake passage and the intake air flow control valve, the second intake air flow generating opening being provided at the other of the intake air flow control valve and the portion between the inner surface of the intake passage and the intake air flow control valve,
the intake air flow control valve rotating to achieve a switching between a first intake air flow state and a second intake air flow state, the first intake air flow state where the first intake air flow generating opening is opened and the second intake air flow generating opening is fully closed at the first side in the rotation direction of the intake air flow control valve, the second intake air flow state where the first intake air flow generating opening is fully closed and the second intake air flow generating opening is opened at the second side in the rotation direction of the intake air flow control valve.
